(19) United States
(12) Patent Application Publication
(10) Pub. No.: US 2004/0044505 A1
(43) Pub. Date: Mar. 4, 2004

(54) Method and system for identifying risk factors

(76) Inventor: Richard Horwitz, Pleasantville, NY (US)

Correspondence Address: Jean-Marc Zimmerman, Moses & Singer, LLP, 1301 Avenue of the Americas, New York, NY, 10019, US

(21) Appl. No.: 10/373,553

(22) Filed: Feb. 25, 2003

Related U.S. Application Data
(60) Provisional application No. 60/408,161, filed on Sep. 4, 2002.

(51) Int. Cl. G06F 17/60

(52) U.S. Cl. 703/3; 705/35; 705/37; 705/34

(57) ABSTRACT

A method for calculating a risk factor associated with a security is provided and includes the steps of tabulating data pertaining to the security; calculating a plurality equity style factors; calculating equity industry factors and orthogonalizing the risk factors.

### CROSS-REFERENCE TO RELATED APPLICATION

This application claims the benefit of the filing date of U.S. provisional application serial No. 60/408,161 entitled “Method and System for Identifying Risk Factors” that was filed on Sep. 4, 2002, the contents of which are incorporated by reference herein.

### BACKGROUND

The following invention relates to a system and method for identifying risk factors and, in particular, to a system and method for identifying risks factors associated with a particular asset.

The existing risk management systems traditionally fall into two categories: pre-trade analytic systems and value-at-risk (VaR) systems. Pre-trade analytic systems have been typically used by the buy-side to construct a portfolio of equity securities within certain risk parameters. These systems are generally based on risk factors developed using extremely long monthly histories that capture structural relationships between securities but that are unresponsive to changing markets. These risk factors provide a framework around which the source of risk can be understood and risk-efficient portfolios constructed. Pre-trade analytic systems have typically been used by traditional, long-only money managers that serve clients with extremely long-term investment horizons such as pension funds. Because pre-trade analytic systems focus on developing portfolios and measuring structural risk, such systems do not capture security specific risk that is “non-structural” that represents more than half of the total risk of a typical long-only equity portfolio and significantly more than half of the risk of many alternative investment strategies. Also, because pre-trade analytic systems generally calculate a basic VaR using a limited parametric model, they do not adequately handle risk related to many strategies utilized in alternative investments, particularly hedge funds. For example, hedge funds utilize long/short strategies that target relative value and spread relationships. Furthermore, hedge funds often use options and other instruments that result in convexity. Hedge funds often use short-term, trading-oriented strategies. Finally, alternative investments often use leverage (including instruments with internal leverage).

VaR systems are used to analyze and assess the risk level of a particular portfolio of securities. These systems provide a measurement of risk in terms of potential future financial loss on the portfolio within a given timeframe. VaR systems have traditionally been used for the sell-side and have been more recently used for the buy-side as well. While VaR systems are useful for measuring the expected aggregate risk associated with a particular portfolio, they do not explain the sources of such risk.

Accordingly, it is desirable to provide a system and method for identifying risks factors associated with a particular security.

### SUMMARY OF THE INVENTION

The present invention is directed to overcoming the drawbacks of the prior art. Under the present invention a method for calculating a risk factor associated with a security is provided and includes the steps of tabulating data pertaining to the security; calculating a plurality equity style factors; calculating equity industry factors and orthogonalizing the risk factors.

In an exemplary embodiment, the data includes price information, dividend information, fundamental data and multi-class share information.

In an exemplary embodiment, the fundamental data includes trailing 12 month earning per share data, trailing 12 month dividends per share data, book per share, balance sheet shares information, turnover, and currency information.

In an exemplary embodiment, the method includes the step of adjusting the price and dividend information for currencies and calculating the daily returns for the security.

In an exemplary embodiment, the method includes the step of aligning the fundamental data, currency converting the fundamental data and distributing the balance sheet shares across each of the share classes of the multiclass shares.

In an exemplary embodiment, the plurality of equity style factors include value, large cap, EPS growth, EPS variability, return volatility, leverage and illiquidity.

In an exemplary embodiment, the step of calculating a plurality of equity style factors includes the steps of identifying a plurality of groupings of securities by country/region and selecting a sub-universe of securities for each of the grouping using the plurality of style factors.

In an exemplary embodiment, the step of selecting a sub-universe includes the step of creating a market cap weighted index of daily returns of each sub-universe for each style factor for each country/region.

In an exemplary embodiment, the plurality of style factors include earnings momentum, merger arbitrage and idiosyncratic style factors.

In an exemplary embodiment, the step of calculating equity industry factors includes the step of segmenting securities for each country/region by GICS level 2 grouping and creating a market cap weighted index of the daily returns of each group of securities for each country/region.

In an exemplary embodiment, the securities are commodities and the industry factors include energies, grains, tropicals, meats, precious metals and base metals.

In an exemplary embodiment, the step of orthogonalizing the risk factors includes the step of sequentially regressing a return history of dependent risk factors with return histories of independent risk factors.

In an exemplary embodiment, the method includes the step of determining a sensitivity of the security to risk associated with the plurality of risk factors.

In an exemplary embodiment, the step of determining at least one risk factor sensitivity includes the steps of calculating a plurality of risk factors associated with the security, the plurality of risk factors including industry risk factors and style risk factors, calculating a daily risk factor for the security for each of the plurality of securities, aligning the daily risk factors with daily returns for the security, forming a matrix calendar days as rows and the plurality risk factors as columns, performing a regression on the matrix, eliminating the industry risk factors having negative sensitivities, eliminating style risk factors having a t-Stats value less than 1.65, rerunning the regression, determining a daily modeled return for the security and calculating a daily residual by subtracting the daily-modeled return from the actual daily return for the security.

In an exemplary embodiment, the security is included in a portfolio of securities and wherein the method further comprises the step of performing portfolio analysis to the portfolio of securities.

In an exemplary embodiment, the step of performing portfolio analysis includes the steps of creating a long-term history based on the risk factors and performing an idiosyncratic risk analysis.

In an exemplary embodiment, the method includes the step of performing a risk factor based risk decomposition and a risk factor based performance attribution.

In an exemplary embodiment, the method includes the step of performing other financial analyses including an analysis of returns (e.g., compound annual, percent up months), volatility (e.g., standard deviation, downside deviation, semi deviation, tracking error), correlation (e.g., correlation coefficient, beta, alpha), risk-return measures (e.g., Sharpe, Sortino, information ratios), leverage, and the distribution of residuals (e.g., kurtosis, skew).

In an exemplary embodiment, the step of creating a long-term history includes the step of calculating the daily risk factor returns for each risk factor, compounding monthly daily risk factor returns and multiplying the compounded monthly returns by the risk factor sensitivities of each security in the portfolio.

In an exemplary embodiment, the method includes decomposing risk into structural, correlated idiosyncratic, and independent idiosyncratic risk. Furthermore, the structural idiosyncratic risk should be further decomposed into its constituent parts based on marginal risk measures. These marginal risk measures should include marginal standard deviation, marginal drawdown, and marginal Value at Risk (VaR), where the VaR confidence limit can be flexibly defined (the VaR confidence limit is the level of confidence of the level of loss one can sustain).

In an exemplary embodiment, the risk factors are used to analyze manager value added, attributing fund performance into structural non-discretionary (the return generated by the managers average structural risk exposures), structural discretionary (the return generated by the managers active management of structural risk exposures), and idiosyncratic returns (the residual after all the returns related to structural exposures are removed).

In an exemplary embodiment, the step of performing idiosyncratic analysis includes the step of determining a level of multicolinearity across securities in the portfolio and measuring serial correlation.

In an exemplary embodiment, the step of determining a level of multicolinearity includes the step of measuring by regressing an idiosyncratic return of each security in the portfolio versus an idiosyncratic return of the entire portfolio excluding the each security.

In an exemplary embodiment, the step of measuring serial correlation includes the step of accumulating weekly idiosyncratic returns of the portfolio of securities for a period.

In an exemplary embodiment, the period is a four-week period.

In an exemplary embodiment, the method includes decomposing risk into structural, correlated idiosyncratic, and independent idiosyncratic risk. Furthermore, the structural idiosyncratic risk should be further decomposed into its constituent parts based on marginal risk measures. These marginal risk measures should include marginal standard deviation, marginal drawdown, and marginal Value at Risk (VaR), where the VaR confidence limit can be flexibly defined (the VaR confidence limit is the level of confidence of the level of loss one can sustain).

In an exemplary embodiment, the risk factors are used to analyze manager value added, attributing fund performance into structural non-discretionary (the return generated by the managers average structural risk exposures), structural discretionary (the return generated by the managers active management of structural risk exposures), and idiosyncratic returns (the residual after all structural exposures are removed).

Under the present invention, computer executable program code residing on a computer-readable medium is provided in which the program code comprises instructions for causing the computer to calculate a risk factor associated with a security, tabulate data pertaining to the security, calculate a plurality equity style factors, calculate equity industry factors and orthogonalize the risk factors.

In an exemplary embodiment, the program code additionally causes the computer to adjust the price and dividend information for currencies and calculating the daily returns for the security.

In an exemplary embodiment, the program code additionally causes the computer to align the fundamental data, currency convert the fundamental data and distribute the balance sheet shares across each of the share classes of the multiclass shares.

In an exemplary embodiment, the program code additionally causes the computer to identify a plurality of groupings of securities by country/region and select a sub-universe of securities for each of the grouping using the plurality of style factors.

In an exemplary embodiment, the program code additionally causes the computer to create a market cap weighted index of daily returns of each sub-universe for each style factor for each country/region.

In an exemplary embodiment, the program code additionally causes the computer to segment securities for each country/region by GICS level 2 grouping and create a market cap weighted index of the daily returns of each group of securities for each country/region.

In an exemplary embodiment, the program code additionally causes the computer to sequentially regress a return history of dependent risk factors with return histories of independent risk factors.

In an exemplary embodiment, the program code additionally causes the computer to determine a sensitivity of the security to risk associated with the plurality of risk factors.

In an exemplary embodiment, the program code additionally causes the computer to calculate a plurality of risk factors associated with the security, the plurality of risk factors including industry risk factors and style risk factors, calculate a daily risk factor for the security for each of the plurality of securities, align the daily risk factors with daily returns for the security, form a matrix calendar days as rows and the plurality risk factors as columns, perform a regression on the matrix, eliminate the industry risk factors having negative sensitivities, eliminate style risk factors having a t-Stats value less than 1.65, determine a daily modeled return for the security and calculate a daily residual by subtracting the daily-modeled return from the actual daily return for the security.

In an exemplary embodiment, wherein the security is included in a portfolio of securities and wherein the program code additionally causes the computer to perform portfolio analysis to the portfolio of securities.

In an exemplary embodiment, the program code additionally causes the computer to create a long-term history based on the risk factors and perform an idiosyncratic risk analysis.

In an exemplary embodiment, the program code additionally causes the computer to perform a risk factor based risk decomposition and a risk factor based performance attribution.

In an exemplary embodiment, the program code additionally causes the computer to perform other financial analyses including the analysis of returns (e.g., compound annual, percent up months), volatility (e.g., standard deviation, downside deviation, semi deviation, tracking error), correlation (e.g., correlation coefficient, beta, alpha), risk-return measures (e.g., Sharpe, Sortino, information ratios), leverage, and the distribution of residuals (e.g., kurtosis, skew).

In an exemplary embodiment, the program code additionally causes the computer to calculate the daily risk factor returns for each risk factor, compound monthly daily risk factor returns and multiply the compounded monthly returns by the risk factor sensitivities of each security in the portfolio.

In an exemplary embodiment, the program code additionally causes the computer to decompose risk into structural, correlated idiosyncratic, and independent idiosyncratic risk. Furthermore, the structural idiosyncratic risk should be further decomposed into its constituent parts based on marginal risk measures. These marginal risk measures should include marginal standard deviation, marginal drawdown, and marginal Value at Risk (VaR), where the VaR confidence limit can be flexibly defined (the VaR confidence limit is the level of confidence on the level of loss one can sustain that statistically defines the VaR threshold).

In an exemplary embodiment, the program code additionally causes the computer to analyze the manager's value added, attributing fund performance into structural non-discretionary (the return generated by the managers average structural risk exposures), structural discretionary (the return generated by the managers active management of structural risk exposures), and idiosyncratic returns (the residual after all structural exposures are removed).

In an exemplary embodiment, the program code additionally causes the computer to determine a level of multicolinearity across securities in the portfolio and measure serial correlation.

In an exemplary embodiment, the program code additionally causes the computer to measure by regressing an idiosyncratic return of each security in the portfolio versus an idiosyncratic return of the entire portfolio excluding the each security.

In an exemplary embodiment, the program code additionally causes the computer to accumulate weekly idiosyncratic returns of the portfolio of securities for a period.

Accordingly, a method and system is provided for calculating and maintaining risks factors associated with a particular security included in a basket of securities and for using those risk factors to analyze the risk profile of the portfolio.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a block diagram of a system architecture for identifying and applying risk factors for analyzing portfolio performance, according to the present invention;

FIG. 2 is a flowchart describing the Calculate Risk Factors function according to the method of the present invention; and

FIG. 3 is a flowchart of the Perform Sensitivity Analysis function according to the present invention.

### DETAILED DESCRIPTION OF THE PREFERRED EMBODIMENTS

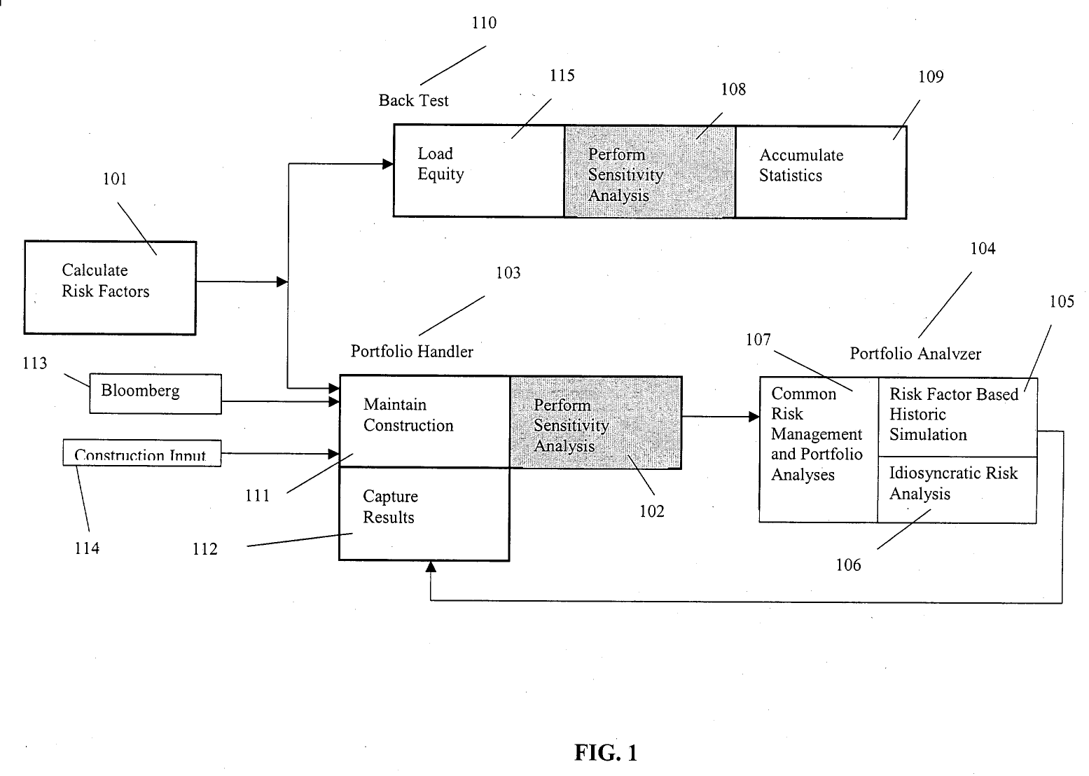

Referring now to FIG. 1, there is shown a block diagram of a system architecture for identifying and applying risk factors for analyzing portfolio performance. The system architecture includes a Calculate Risk Factor function 101 that calculates risk factors associated with a security (e.g., an equity or commodity). Also included is a Portfolio Handler Function 103 that performs a sensitivity analysis of a particular portfolio of securities to the risk factors calculated by Calculate Risk factor function 101. A Portfolio Analyzer function 104 is also included and involves the creation of a long-term history by applying the risk factors in a historical simulation and other related risk factor based analyses including, by way of non-limiting example, a risk factor based risk decomposition, risk factor based performance attribution and analysis of idiosyncratic risk using the residuals of the risk factor model. Portfolio Analyzer function 104 also performs other risk management and portfolio analytics based on the risk factors. Finally, a Back test function 110 is included in which the risk factors are iteratively applied to a set of securities and statistics on the quality of the explanatory power is calculated. The primary measure of the quality of the explanatory power is the market capitalization weighted average of the R² (R squared) of the sensitivity analyses (regressions) that established the risk sensitivities. The R² measures the square root of the sum of the squared residuals, and is a standard statistical measure for the quality of fit in a least-square regression.

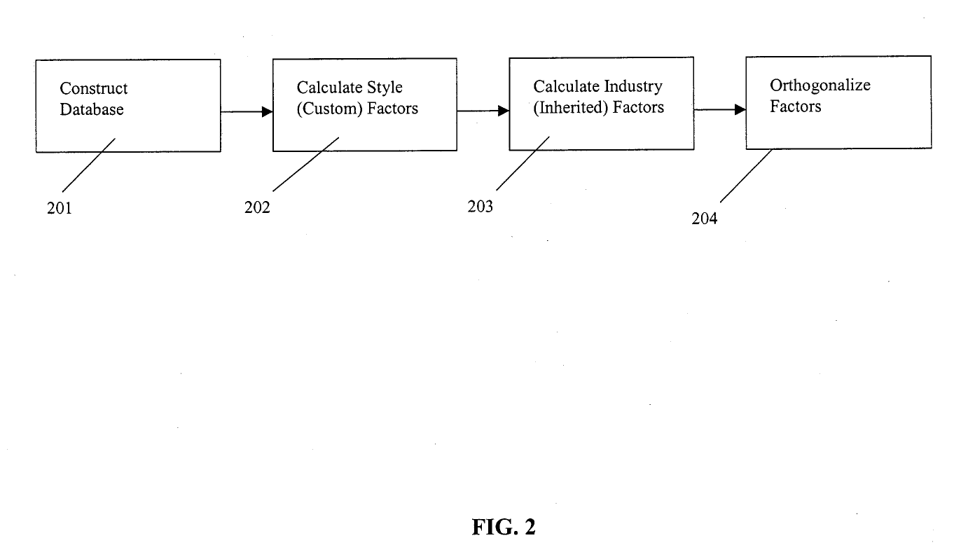

Referring now to FIG. 2, there is shown a flowchart detailing Calculate Risk Factors function 101 in which risk factors are calculated according to the method of the present invention. Initially, in Step 201 a risk factor database is constructed. The construction of the risk factor database includes retrieving data from, by way of non-limiting example, Bloomberg or any other suitable data source and tabulating all of the requisite data for each particular security including price information, dividend information, fundamental data (including, by way of non-limiting example, trailing 12 month EPS, trailing 12 month DPS, book per share, EPS over the previous 6 years, Debt/Equity, balance sheet shares, turnover, and currency information) and multi-class share information. In an exemplary embodiment, the price and dividend information (selecting only the specific types of dividends that represent a cash flow or equivalent value provided to the holder of the equity) are adjusted for currencies and the daily returns for each security is calculated; the fundamental data are aligned and currency converted and, for the multiclass shares, the balance sheet shares are distributed across each of the share classes

Next, in Step 202, equity style factors are used to create a sub-universe of stocks in each country/region. In an exemplary embodiment, Table 1 lists seven style factors with each style factor having associated therewith a rule by which a respective sub-universe is established. (with appropriate currency conversions):

TABLE 1

| | Sub- | | |
|---|---|---|---|
| Style Factor | Universe | Rank | Criterion |
| Large Cap | Top 2% | Descending | Sum of Market Capitalizaiton |
| | | | of All Share Classes |
| Value | Top 20% | Descending | Earnings/Price + |
| | | | .15* Book/Price + |
| | | | 2.5* Dividend Yield |
| EPS Growth | Top 20% | Descending | [Average(EPS trailing |
| | | | 3 years) − Average |
| | | | (EPS trailing 6 to 4 years)]/ |
| | | | Average(EPS trailing 6 years) |
| EPS | Top 20% | Descending | StdDev(Trailing 6 year EPS)/ |
| Variability | | | Average(Trailing 6 year EPS) |
| Return | Top 20% | Descending | StdDev(Daily Returns |
| Volatility | | | Last Two Months) |
| Leverage | Top 20% | Descending | Total Debt/Equity |
| Illiquidity | Top 20% | Descending | Shares Outstanding/ |
| | | | Last Month's Trade Volume |

For each style factor, a sub-universe of securities that demonstrate this behavior is formed and a market cap weighted index of the performance of these securities is created. Each style factor is calculated by creating a market cap weighted index of the daily returns of each style sub-universe for the country/region. Shown in Table 2 is an example of how a market capitalization weighted index is calculated (the stock is included in the sub-universe for a particular day if the value is 1 and it is excluded if the value is 0). The market capitalization for each day is the market capitalization of the previous day adjusted for the return on that day.

TABLE 2

| | Daily Returns | | | Included In Universe | | | Market Capitalization | | | Cap Wght |
|---|---|---|---|---|---|---|---|---|---|---|
| | Stock A | Stock B | Stock C | Stock A | Stock B | Stock C | Stock A | Stock B | Stock C | Index |
| Day 1 | 1% | 2% | −3% | 1 | 1 | 0 | 100 | 200 | 150 | 1.67% |
| Day 2 | −1% | 2% | −2% | 1 | 1 | 0 | 99 | 204 | 147 | 1.02% |
| Day 3 | 1% | 2% | −1% | 1 | 1 | 0 | 100 | 208 | 146 | 1.68% |
| Day 4 | −1% | 2% | 0% | 1 | 1 | 1 | 99 | 212 | 146 | 0.71% |
| Day 5 | 1% | 2% | 1% | 1 | 1 | 1 | 100 | 216 | 147 | 1.47% |
| Day 6 | −1% | 0% | 2% | 1 | 1 | 1 | 99 | 216 | 150 | 0.43% |
| Day 7 | 1% | 0% | 3% | 1 | 1 | 1 | 100 | 216 | 154 | 1.20% |
| Day 8 | −1% | 0% | 2% | 1 | 1 | 1 | 99 | 216 | 158 | 0.46% |
| Day 9 | 1% | 0% | 1% | 0 | 1 | 1 | 100 | 216 | 159 | 0.42% |
| Day 10 | −1% | 2% | 0% | 0 | 1 | 1 | 99 | 221 | 159 | 1.16% |

For days that an individual security did not trade or had not traded on the previous day that the market was open, that particular security is excluded. Because the behavior of securities changes over time, the contents of each sub-universe will correspondingly change over time.

In addition to the style factors listed above, additional equity style factors may be used including momentum-oriented risk factors (earnings or price momentum), hedge fund style factors such as merger arbitrage, or an idiosyncratic style factor. In an exemplary embodiment, risk factors for commodities are used employing the same methodology described above but by replacing equities with continuous forward returns (available from the generic forward Bloomberg functions). Similarly, style factors from other asset classes (e.g., value used for equity or interest rates) may also be used with commodities (the statistical relationship between the performance of commodities and the performance of risk factors of other assets will be explicitly incorporated).

Next, in Step 203, equity industry factors are calculated by segmenting the securities for each country/region by GICS level 2 grouping (23 groupings) and creating a market cap weighted index of the daily returns of each group for each country/region. The four level GICS groupings, (an acronym for Global Industry Classification Standard), has been established by Standard & Poors. For days that individual securities did not trade or that did not trade on the previous day for which the market was open, the security is excluded. For the 1500 U.S. equities for which Standard & Poors provides a GICS grouping, that grouping is selected. For all other U.S securities and all international securities for which Standard & Poors does not provide a GICS grouping, the security is mapped to a GICS grouping based on the sub-industry assigned by Bloomberg and a mapping of Bloomberg sub-industries to GICS level 4 groupings. For example, Amphenol Corp (APH) has been assigned a Bloomberg subgroup of “Electronic_Components”. Bloomberg subgroup “Electronic _Components” has been mapped to GICS Level 2 group “Capital Goods”. Consequently, the “Capital Goods” industry risk factor will be associated with APH. For individual securities that have significant exposure to multiple industries, multiple industry mappings are used and, consequently, these stocks are excluded from the calculation of industry factors. For example, General Electric has exposures to multiple industries (e.g., financial services, healthcare, basic materials, industrials, and entertainment) and is therefore excluded from the calculation of any specific industry risk factor.

In an exemplary embodiment, risk factors for commodities use the same methodology described above by replacing equities with continuous forward returns (available from the generic forward Bloomberg functions). Also, a set of industry groupings for the commodity industry risk factors are used and may include, by way of non-limiting example, the following groupings:

Energies

Grains

Tropicals

Meats

Precious Metals

Base Metals

Next, in Step 204, the risk factors calculated above are orthogonalized to make them statistically independent. The process of orthogonalizing the risk factors includes sequentially regressing the return history of dependent risk factors with the return histories of independent risk factors thereby creating a residual return history that is independent of all the independent risk factors. Shown below in Table 3 is an example of three “natural” risk factors that are not independent and the “orthogonalized” set that results from regressing RF2 with RF land then regressing RF3 with both RF1 and RF2 (see regressions at the bottom of the worksheet). Consequently, the set of risk factors on the right is orthogonalized.

TABLE 3

| | Natural Returns | | | Orthagonilized Returns | | |
|---|---|---|---|---|---|---|
| | RF1 | RF2 | RF3 | RF1 | RF2 | RF3 |
| Day 1 | −0.3% | −0.4% | 1.1% | −0.3% | −0.1% | 1.6% |
| Day 2 | 1.7% | −1.5% | −2.9% | 1.7% | −3.3% | −0.9% |
| Day 3 | −0.7% | −3.2% | −5.8% | −0.7% | −2.5% | −1.3% |
| Day 4 | −2.1% | −3.1% | −3.8% | −2.1% | −0.9% | 0.6% |
| Day 5 | −0.3% | −0.9% | 0.3% | −0.3% | −0.6% | 1.5% |
| Day 6 | −0.5% | 0.8% | 1.0% | −0.5% | 1.3% | 0.0% |
| Day 7 | 1.7% | 2.0% | 4.4% | 1.7% | 0.3% | 1.5% |
| Day 8 | −0.1% | 0.1% | 1.6% | −0.1% | 0.2% | 1.4% |
| Day 9 | −1.4% | −2.3% | −3.9% | −1.4% | −0.9% | −0.5% |
| Day 10 | 0.0% | −1.0% | 0.4% | 0.0% | −1.1% | 1.8% |
| Day 11 | −2.6% | −0.4% | −0.9% | −2.6% | 2.2% | −0.1% |
| Day 12 | 0.5% | 0.2% | −0.3% | 0.5% | −0.2% | −0.7% |
| Day 13 | 0.7% | 1.1% | 0.3% | 0.7% | 0.5% | −1.3% |
| Day 14 | 0.6% | 1.2% | 0.8% | 0.6% | 0.6% | −0.9% |
| Day 15 | 0.1% | 0.0% | −0.1% | 0.1% | −0.1% | −0.1% |
| Day 16 | 1.1% | 0.5% | −0.4% | 1.1% | −0.6% | −1.3% |
| Day 17 | 2.2% | 3.7% | 5.0% | 2.2% | 1.4% | −0.3% |
| Day 18 | 0.5% | 1.3% | 1.0% | 0.5% | 0.8% | −0.8% |
| Day 19 | 0.4% | 2.3% | 3.8% | 0.4% | 1.9% | 0.5% |
| Day 20 | −0.3% | −1.6% | −2.9% | −0.3% | −1.3% | −0.6% |

| Orthagonalizing RF2 | | | Orthagonalizing RF3 | | |
|---|---|---|---|---|---|
| RF1 | Intercept | | RF1 | RF2 | Intercept |
| 0.94 | 0.00 | #N/A | 1.49 | 1.38 | 0 |
| 0.26 | #N/A | #N/A | 0.18 | 0.21 | #N/A |
| 0.41 | 0.01 | #N/A | 0.85 | 0.01 | #N/A |
| 13 | 19 | #N/A | 53 | 18 | #N/A |

In and exemplary embodiment, the process is performed for risk factors in the following sequence: Beta, Large Cap, Value, Other Style Factors and Industry Factors. This sequence attributes the greatest amount of correlated risk to the risk factor that is the easiest to manage in constructing a portfolio. It permits the greatest level of natural hedging thereby avoiding inefficient offsetting risk exposures resulting from hedging specific industry exposures. For example, if a portfolio is long a tech stock that is negatively exposed to value, and long a basic materials that is positively exposed to value, these exposures to value naturally hedge each other out. If one first orthogonalized industry risk factors before sector risk factors, this natural relationship would be masked.

Portfolio Handler function 103 includes a Perform Sensitivity Analysis function 102 in which the sensitivity of a particular security to each risk factor is calculated. Portfolio Handler function 103 also includes a Maintain Construction function 111 that receives input from a data source 113 (that may be, by way of non-limiting example, a Bloomberg data service) and a Construction input 114 (that identifies the individual securities included in the portfolio construction). The Maintain Construction function 111 supports the direct entry and the update of the portfolio construction and the related data. Portfolio Handler function 103 also includes a Capture results function 112 that capture results from Portfolio Analyzer function 104 so that results of a later construction can be compared to comparable results for previous constructions. For example, the Sharpe ratio of the current portfolio will be compared to the same measure for each of the last constructions of each of the previous months.

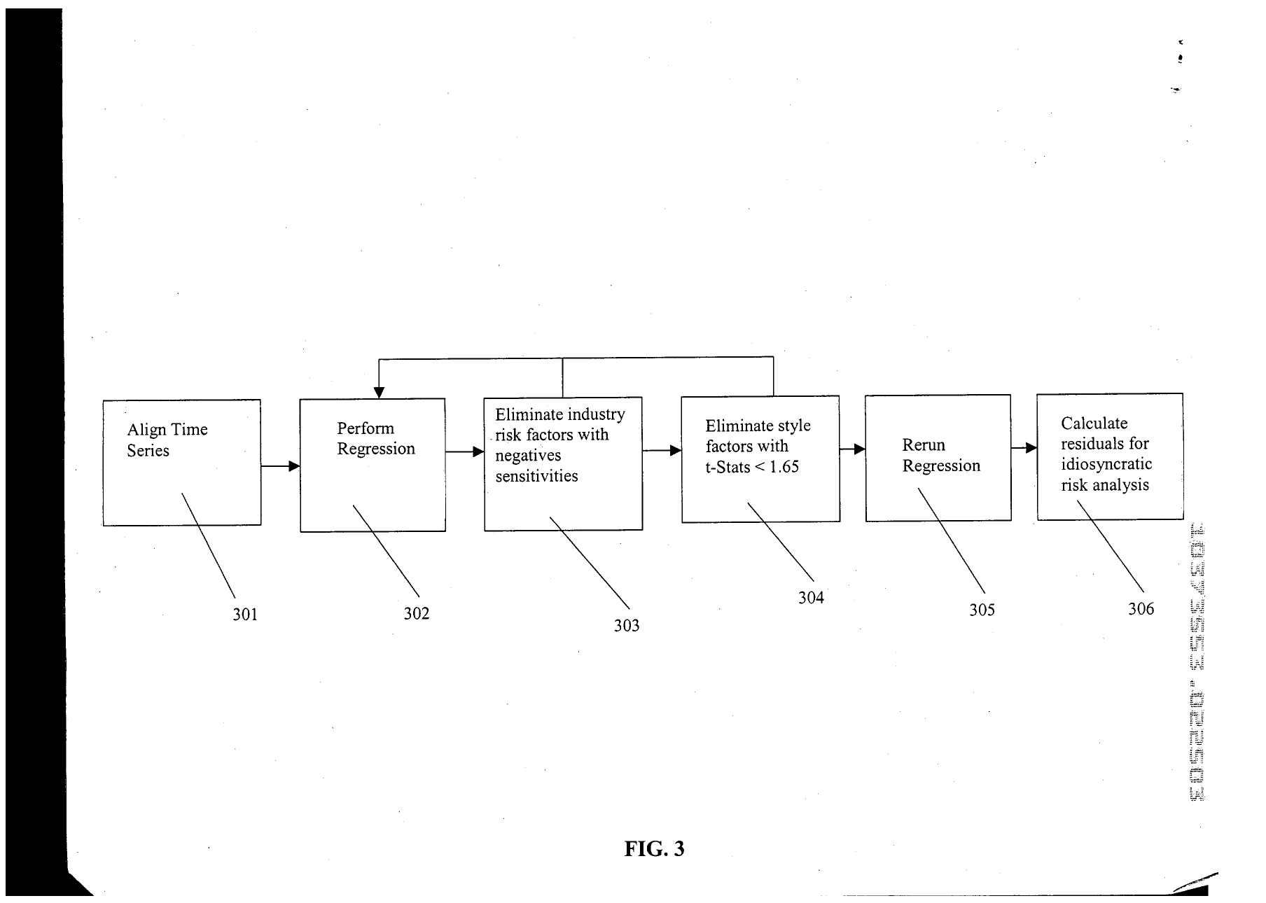

Referring now to FIG. 3, there is shown a flowchart of Perform Sensitivity Analysis function 103. Initially, in Step 301, the time series that include daily risk factors and daily returns for the particular security are aligned. Because there are risk factors for every day that the securities markets are open, the alignment in this step is based on whether the particular security trades on a given day that the markets are open. In an exemplary embodiment, a matrix is constructed having calendar days as rows and the relevant risk factors (e.g., the beta risk factor, all the style risk factors, and one or more of the industry risk factors) as columns. If the particular security does not trade on a particular day, no row will be created in the matrix for that day. For days that the security does trade, a row is inserted that includes the return of the security since the previous day the security traded. The entries for the return of each of the relevant risk factors will be the compound return of the risk factor since the day the stock last traded. Shown in Table 4 is an example of the alignment of a stock and a risk factor over a ten-day period. The stock traded, and consequently had closing prices, on all days besides day six and seven. In addition, the stock received a dividend on the fourth and the seventh day. One can see that the returns were calculated for each day in which the stock traded and that the dividend in day seven (a day that the stock did not trade) was accumulated into the return of day eight (the next day that the stock traded). Finally, the return of the risk factor for day six and seven (the days in which the stock did not trade) were accumulated into day eight so that the periods of the risk factor history paralleled that of the stock.

TABLE 4

| | RF | Price | Dividend | Stock | RF |
|---|---|---|---|---|---|
| Day 0 | | 100.00 | | | |
| Day 1 | 1.2% | 101.16 | | 1.2% | 1.2% |
| Day 2 | 1.5% | 104.25 | | 3.1% | 1.5% |
| Day 3 | −0.4% | 103.88 | | −0.4% | −0.4% |
| Day 4 | 1.5% | 102.27 | 2.00 | 0.4% | 1.5% |
| Day 5 | 0.8% | 104.02 | | 1.7% | 0.8% |
| Day 6 | −1.4% | | | | |
| Day 7 | −0.7% | | 1.00 | | |
| Day 8 | −1.6% | 100.51 | | −2.4% | −3.6% |
| Day 9 | 1.5% | 101.09 | | 0.6% | 1.5% |
| Day 10 | −0.9% | 102.51 | | 1.4% | −0.9% |

Next, in Step 302, a regression is performed on the matrix of returns formed in Step 301 using the return of the security as the dependent variable in the regression and the returns of the risk factors as the independent variables in the regression. The result of the regression is a linear model that minimizes the sum of the squared errors of the model.

Next, in Step 303, industry risk factors with negative sensitivities are eliminated. If the regression results generated in Step 302 results in negative sensitivities for any of the industry risk factors, the industry risk factor is eliminated from subsequent regressions for the particular security. Negative sensitivities are statistical aberrations because the security is known to have a commercial exposure to the industry group and therefore a negative sensitivity to the industry risk factor is not logical. Therefore, sensitivities to industry risk factors are assumed to be zero.

Next, in Step 304, style factors with t-Stats less than 1.65 are eliminated. If any of the risk factors in the regression have a t-Stat less than 1.65, the risk factor is eliminated from subsequent regressions. (A t-statistic is a statistical test that measures the likelihood that a sensitivity to a risk factor (or an independent variable in its more generic form) is statistically significant. A 1.65 t-statistic implies that there is a 95% probability that the return is sensitive to the respective risk factor.) Because there is a high level of multi-colinearity across risk factors, eliminating statistically insignificant risk factors avoids large sensitivities to offsetting correlated risk factors, neither of which is significant.

Next, in Step 305, the regression process will be repeated with the reduced set of statistically significant risk factors if columns have been eliminated because an industry risk factor had a negative sensitivity or a style risk factor had a t-Stat <1.65.

Next, in Step 306, the daily residual is calculated for each security by first calculating the daily-modeled return of that security for that day based on the risk factor sensitivities and that day's returns of each risk factor. The daily residual, or idiosyncratic return, is then calculated by subtracting the daily-modeled return from the actual return of that day. For example, if a stock has a sensitivity to the market (beta) of 1, a sensitivity to value of −0.5, and a sensitivity to technology of 1.5 and each of these risk performed as follows over a ten day period, the modeled return of that security would be those shown in the following chart. Consequently, the daily residuals would be the difference between the actual returns and the modeled returns, as are shown in Table 5.

TABLE 5

| | Actual | Daily Risk Factor Returns | | | Modeled | Daily |
|---|---|---|---|---|---|---|
| | Returns | Beta | Value | Tech | Returns | Residuals |
| Day 1 | −1% | 1% | 2% | −3% | −5% | 4% |
| Day 2 | −1% | −1% | 2% | −2% | −5% | 4% |
| Day 3 | −1% | 1% | 2% | −1% | −2% | 1% |
| Day 4 | −1% | −1% | 2% | 0% | −2% | 1% |
| Day 5 | −1% | 1% | 2% | 1% | 2% | −3% |
| Day 6 | −1% | −1% | 0% | 2% | 2% | −3% |
| Day 7 | −1% | 1% | 0% | 3% | 6% | −7% |
| Day 8 | −1% | −1% | 0% | 2% | 2% | −3% |
| Day 9 | −1% | 1% | 0% | 1% | 3% | −4% |
| Day 10 | −1% | −1% | 2% | 0% | −2% | 1% |

Portfolio Analyzer function 104 includes a Risk Management and Portfolio Analysis function 107 that performs a variety of risk management and portfolio analyses to a selected portfolio of securities. This may include any suitable techniques including, by way of non-limiting example, analysis of returns (e.g., compound annual, percent up months), volatility (e.g., standard deviation, downside deviation, semi deviation, tracking error), correlation (e.g., correlation coefficient, beta, alpha), risk-return measures (e.g., Sharpe, Sortino, information ratios), leverage, and the distribution of residuals (e.g., kurtosis, skew). In an exemplary embodiment, the risk management and portfolio analyses are based on the historical simulation results performed by Historical Simulation function 105 using the risk factors (as described below).

Also included in Portfolio Analyzer function 104 is a Risk Factor Based Historic Simulation function 105 in which a long-term history is created by applying the calculated risk factors using an historical simulation and performing other related risk factor based analyses including, by way of non-limiting example, a risk factor based risk decomposition and a risk factor based performance attribution.

In an exemplary embodiment, Risk Factor Based Historic Simulation function 105 utilizes the risk factor sensitivities calculated over a relatively short period of time (for example, 1 year) that are generated by Perform Sensitivity Analysis function 102 and applies the calculated risk factor sensitivities to long-term market conditions. By applying the risk factor sensitivities in this manner, it can be determined how a given portfolio might have performed over a long-term history given the risk factor sensitivities calculated based on current market conditions. Accordingly, the application of a historical simulation permits the full distribution of returns to be analyzed including asymmetries (returns that are not symmetrical around the mean as is a normal distribution) and fat tails (also called kurtosis—the tails of the distribution being more dispersed than those characterized by a normal distribution).

In an exemplary embodiment, Historic Simulation function 105 compounds monthly the daily risk factor returns and these monthly returns for each risk factor is multiplied by the risk factor sensitivities of each security in the portfolio is used to determine what the return of that security would have been for each historical month. Shown in Table 6 is an example of a twelve-month historical simulation of three risk factors. The figures in the rectangle are the monthly returns of each risk factor. The shaded figures are the sensitivities of the hypothetical security to each risk factor.

TABLE 6

| | Risk Factor Returns | | | Historical |
|---|---|---|---|---|
| | RF1 | RF2 | RF3 | Simulation |
| Month 1 | 1.4% | −0.5% | −3.9% | 0.5% |
| Month 2 | 2.0% | 0.3% | −1.6% | 1.4% |
| Month 3 | 2.4% | 0.5% | −0.7% | 1.9% |
| Month 4 | −5.1% | −4.7% | −4.4% | −4.0% |
| Month 5 | −3.1% | −3.0% | −3.8% | −2.7% |
| Month 6 | 4.1% | 2.5% | 1.2% | 3.2% |
| Month 7 | 3.6% | 1.2% | −4.0% | 1.7% |
| Month 8 | −2.6% | −3.6% | −6.8% | −2.8% |
| Month 9 | 1.6% | 0.6% | 3.1% | 2.2% |
| Month 10 | 5.2% | 5.4% | 7.3% | 4.7% |
| Month 11 | −4.4% | −5.4% | −8.6% | −4.3% |
| Month 12 | 4.7% | 1.5% | −1.6% | 3.4% |
| Sensitivity | 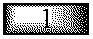 | 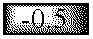 | 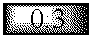 | |

In an exemplary embodiment, this return series generated by Historical Simulation 105 is used by Risk Management and Portfolio Analysis function 107 to calculate a range of common risk management and portfolio analyses. For example, the Sharpe ratio of the example historical simulation presented above would be calculated as follows. The compound annual return during the 12 months was 4.8% and the monthly standard deviation was 3.1% and, consequently, the annualized standard deviation is 10.8% (the monthly standard deviation multiplied by the square root of 12). The Sharpe ratio is a common risk-return measure and is defined as the difference of the annual return of the portfolio minus the risk free rate divided by the annualized standard deviation of the returns of the portfolio. In this example (assuming a 4% risk free rate) this would be (4.8%-4.0%)/10.8% or 0.08.

In an exemplary embodiment, Historical Simulation function 105 performs a decomposition and analysis. The method includes decomposing risk into structural, correlated idiosyncratic, and independent idiosyncratic risk. Furthermore, the structural idiosyncratic risk is further decomposed into its constituent parts based on marginal risk measures. These marginal risk measures include marginal standard deviation, marginal drawdown, and marginal Value at Risk (VaR), where the VaR confidence limit can be flexibly defined (the VaR confidence limit is the level of confidence of the level of loss one can sustain). Furthermore, because a standard set of risk factors are consistently used on a global basis, the benefits of geographic diversification are also quantified. Historical Simulation function 105 also integrates the idiosyncratic returns (as described below) in the decomposition and analysis. The following example (depicted in Table 7 below) demonstrates how the marginal standard deviation is calculated and used to perform the risk decomposition.

First, the historical simulation as described above is performed. The returns of a hypothetical portfolios adding a 1% exposure of each risk factor to the portfolio is calculated as shown. The marginal standard deviation of the returns of each of the hypothetical portfolios is calculated by subtracting the standard deviation of the returns of the historical simulation (presented in the single shaded cell) from the standard deviation of the returns of each of the hypothetical portfolios and multiplying this result by 100. The results are presented in the three contiguous shaded cells. Each of these marginal standard deviations of the returns of their respective hypothetical portfolios is multiplied by the sensitivity of the portfolio to that risk factor (the results are shown in the cells between the shaded row and the row outlined in a black rectangle). The result is then divided by the standard deviation of the historical simulation. This decomposition attributes risk to each of the three risk factors (note that the sum of the attribution equals 100%). The fact that the RF2 has a negative attribution reflects that the sensitivity of this risk factor is negative and therefore incremental exposure will offset this negative exposure and reduce the aggregate risk.

TABLE 7

| | Risk Factor Returns | | | Historical | Hopothetical Portfolio Returns | | |
|---|---|---|---|---|---|---|---|
| | RF1 | RF2 | RF3 | Simulation | RF1 | RF2 | RF3 |
| Month 1 | 1.4% | −0.5% | −3.9% | 0.5% | 0.5% | 0.5% | 0.5% |
| Month 2 | 2.0% | 0.3% | −1.6% | 1.4% | 1.4% | 1.4% | 1.4% |
| Month 3 | 2.4% | 0.5% | −0.7% | 1.9% | 1.9% | 1.9% | 1.9% |
| Month 4 | −5.1% | −4.7% | −4.4% | −4.0% | −4.1% | −4.1% | −4.1% |
| Month 5 | −3.1% | −3.0% | −3.8% | −2.7% | −2.8% | −2.8% | −2.8% |
| Month 6 | 4.1% | 2.5% | 1.2% | 3.2% | 3.2% | 3.2% | 3.2% |
| Month 7 | 3.6% | 1.2% | −4.0% | 1.7% | 1.8% | 1.8% | 1.7% |
| Month 8 | −2.6% | −3.6% | −6.8% | −2.8% | −2.9% | −2.9% | −2.9% |
| Month 9 | 1.6% | 0.6% | 3.1% | 2.2% | 2.2% | 2.2% | 2.3% |
| Month 10 | 5.2% | 5.4% | 7.3% | 4.7% | 4.8% | 4.8% | 4.8% |
| Month 11 | −4.4% | −5.4% | −8.6% | −4.3% | −4.4% | −4.4% | −4.4% |
| Month 12 | 4.7% | 1.5% | −1.6% | 3.4% | 3.5% | 3.5% | 3.4% |
| | | | | | 3.6% | 3.1% | 3.6% |
| Std Dev | | | | 3.1% | 3.6% | −1.5% | 1.1% |
| Senstivity | 1 | −0.5 | 0.3 | | 115% | −50% | 34% |

In an exemplary embodiment, the risk factors are used to analyze manager value added, attributing fund performance into structural non-discretionary (the return generated by the managers average structural risk exposures), structural discretionary (the return generated by the managers active management of structural risk exposures), and idiosyncratic returns (the residual after all structural exposures are removed). Shown in Table 8 is an example of the calculation. The example presents the returns and exposures to a single risk factor over a twelve-month period. The returns represent how that risk factor performed over the period. The exposure represents the aggregate net exposure of each month's portfolio construction. The 105.09% is the average of the monthly exposures. The Average Structural Exposure is the product of that month's return and the average exposure. This represents the monthly returns that the fund would have generated had the manager held the portfolio to a constant average exposure over the 12-month period. In this example the Average Structural Exposure was 0.22%. The Actual Structural Exposure represents the returns that the manager would have generated solely based on the exposure to the single risk factor as it actually evolved over the 12-month period. In this example the Actual Structural Exposure was 0.29%. The Structural Discretionary represents the difference between these performances. In this case the average of the 12-months of the Structural Discretionary was 0.07%. Finally, the Actual Gross Portfolio Return of the fund averaged 0.00%. Consequently, the Idiosyncratic Returns average −0.29% over the 12-month period, indicating that the active decisions that the portfolio manager made beyond those to change the exposure to the single risk factor (e.g., security selection, trading strategy, relatively value strategies) reduced the return.

TABLE 8

| | Actual | | | | | | |
|---|---|---|---|---|---|---|---|
| Structural | Gross | | Actual | Structural | Average | | |
| Non- | Portfolio | Idiosyncratic | Structural | Discre- | Structural | RF1 | |
| Discre- | Returns | Returns | Exposure | tionary | Exposure | | Exposure |
| tionary | 0.00% | −0.29% | 0.29% | 0.07% | 0.22% | Return | 105.09% |
| Month 1 | 0.35% | 0.05% | 0.30% | −0.29% | 0.59% | 0.56% | 53.37% |
| Month 2 | −0.80% | −0.76% | −0.04% | 0.02% | −0.06% | −0.06% | 74.43% |
| Month 3 | 1.25% | 1.00% | 0.25% | 0.04% | 0.21% | 0.20% | 126.55% |
| Month 4 | −0.93% | −2.38% | 1.45% | 0.24% | 1.21% | 1.15% | 126.18% |
| Month 5 | −0.32% | −0.20% | −0.12% | 0.12% | −0.24% | −0.23% | 51.10% |
| Month 6 | 0.58% | −2.68% | 3.26% | 0.88% | 2.38% | 2.27% | 144.01% |
| Month 7 | −0.63% | 0.41% | −1.04% | −0.15% | −0.89% | −0.85% | 122.45% |
| Month 8 | 1.59% | 2.77% | −1.18% | −0.23% | −0.94% | −0.90% | 131.17% |
| Month 9 | 1.07% | 1.67% | −0.60% | 0.17% | −0.77% | −0.74% | 81.80% |
| Month 10 | 0.02% | −0.53% | 0.55% | 0.12% | 0.44% | 0.42% | 133.25% |
| Month 11 | −1.36% | −1.20% | −0.16% | −0.02% | −0.14% | −0.13% | 120.50% |
| Month 12 | −0.82% | −1.60% | 0.78% | −0.07% | 0.85% | 0.81% | 96.32% |

Also included in Portfolio Analyzer function 104 is an Idiosyncratic Risk Analysis function 106 that explicitly calculates the short-term (i.e., the same period for which Perform Sensitivity Analysis function 102 performs the sensitivity analysis—for example, one year) idiosyncratic risk of each security in the portfolio and analyzes the full distribution of idiosyncratic returns, including asymmetries and fat tails, and the correlations across idiosyncratic returns. (Because the idiosyncratic returns are the residuals of the regressions with the relevant risk factors, they are statistically independent of these risk factors.) The daily idiosyncratic returns (residuals) are calculated as described earlier. In an exemplary embodiment, the daily idiosyncratic or residual returns are compounded weekly so that the impact of the staggered trading time windows across time zones is minimized while retaining adequate data to support statistically significant analyses. Portfolios are typically valued at the closing price as provided by the exchanges. However, on a global basis, exchanges close throughout the 24 hour daily window. For example, should the Wednesday closing price in Tokyo be correlated with the Tuesday closing price in New York or the Wednesday closing price in New York. Performing correlation analysis using weekly returns minimizes the problems of asynchronous market closings.

In an exemplary embodiment, Idiosyncratic Risk Analysis function 106 determines the level of multicolinearity among the idiosyncratic returns of securities in the portfolio (that is a measure of whether the idiosyncratic returns of individual securities are statistically independent of those of the other securities in the portfolio) and measures serial correlation of the portfolio's aggregate idiosyncratic returns (that is a measure of whether the idiosyncratic returns of the portfolio of each week are statistically independent of those of earlier or later weeks). The portfolio aggregate weekly idiosyncratic returns are first calculated by calculating the weighted average (weighted based on position size) of the individual idiosyncratic returns of each position in the portfolio. The level of multicolinearity is measured by regressing the idiosyncratic return of each security versus the idiosyncratic return of the entire portfolio excluding that security. The weekly residuals of each of these regressions (one per security in the portfolio) are then combined on a weighted average basis (again weighted based on position size) to calculate the weekly time series of “independent” idiosyncratic returns of the portfolio (having removed correlated idiosyncratic returns). The square of the standard deviation of the weekly “independent” idiosyncratic returns is divided by the sum of the square of the standard deviation of the “independent” idiosyncratic returns plus the square of the standard deviation of the “correlated” independent returns provides a percent independent ratio. The percent independent ratio is an important measure of statistical independence of the idiosyncratic return across a portfolio that is used in the risk factor decomposition to isolate correlated idiosyncratic return from independent idiosyncratic return. For example, traditional risk factors failed to identify the risk of a concentrated exposure to the internet in the late 1990s because the internet had not been identified as a separate risk factor and traditional risk factors assume that all security specific risk is independent and normally distributed. Applying the above described methodology would not have identified the source of risk of a portfolio with concentrated exposures to the internet sector, but it would have identified that the idiosyncratic risk of such a portfolio was highly correlated and therefore the risk was significantly greater than that assumed by the traditional assumption of statistical independence across idiosyncratic returns. Identifying the degree to which idiosyncratic returns are correlated or independent is particularly important in hedge funds, which often explicitly target relative value or spread relationships. Shown in Table 9 and Table 10 is an example of how these calculations are performed. First, the idiosyncratic returns of three stocks over 20 weeks are presented (Table 9). The portfolio idiosyncratic returns during this 20 week period is calculated based on the weight of each stock in the portfolio. The standard deviation of the weekly portfolio idiosyncratic returns is 1.5%.

TABLE 9

| | Stock A | Stock B | Stock C | Portfolio |
|---|---|---|---|---|
| Weight | 50% | 40% | 30% | Idiosyncratic |
| Week 1 | 0.9% | −0.2% | 0.5% | 0.5% |
| Week 2 | −0.9% | −1.3% | −0.8% | −1.2% |
| Week 3 | 1.5% | −0.1% | 0.7% | 0.9% |
| Week 4 | 0.2% | 2.4% | 0.9% | 1.3% |
| Week 5 | −0.5% | −0.4% | 0.5% | −0.3% |
| Week 6 | 2.8% | 3.7% | 2.0% | 3.5% |
| Week 7 | −1.5% | 0.1% | 0.7% | −0.5% |
| Week 8 | 0.7% | −0.2% | −1.2% | −0.1% |
| Week 9 | 0.3% | −0.2% | −1.8% | −0.5% |
| Week 10 | 0.4% | −0.4% | −0.1% | 0.0% |
| Week 11 | −1.5% | −0.1% | 0.7% | −0.6% |
| Week 12 | 0.0% | 1.1% | 0.0% | 0.5% |
| Week 13 | 2.5% | 0.5% | −0.3% | 1.4% |
| Week 14 | 2.3% | −0.8% | 0.7% | 1.1% |
| Week 15 | −2.1% | −1.5% | 0.2% | −1.6% |
| Week 16 | 0.8% | 0.9% | 1.6% | 1.2% |
| Week 17 | 3.8% | 3.2% | 5.1% | 4.7% |
| Week 18 | 2.6% | 1.9% | 2.8% | 2.9% |
| Week 19 | 0.6% | 0.1% | 1.8% | 0.8% |
| Week 20 | 1.6% | 0.4% | −1.1% | 0.7% |

For each stock, the idiosyncratic returns of the hypothetical portfolio excluding that stock are calculated. The regression of the idiosyncratic returns of each stock to those of the hypothetical portfolio excluding that stock is performed and the slope and intercept calculated. The residuals of each regression represent the independent idiosyncratic return for that stock. Finally, the portfolio independent idiosyncratic return for each week is calculated by weighting the independent idiosyncratic return for that week for each stock by the weight of that stock in the portfolio. The standard deviation of the weekly portfolio independent idiosyncratic return was 0.4% versus a 1.5% standard deviation of the weekly total idiosyncratic return.

TABLE 10

| | | | | | Independent Idiosync Return | | | |
|---|---|---|---|---|---|---|---|---|
| | Portfolio | | | | | | | Portfolio |
| Weight | Idiosyncratic | Portfolio Excluding Stock | | | | | | Independent |
| Std Dev | 1.5% | Stock A | Stock B | Stock C | Stock A | Stock B | Stock C | 0.4% |
| Slope | | 1.05 | 0.94 | 0.77 | | | | |
| Intercept | | 0.0033 | −0.0007 | 0.0023 | | | | |
| Week 1 | 0.5% | 0.0% | 0.6% | 0.4% | 0.5% | −0.7% | 0.0% | 0.0% |
| Week 2 | −1.2% | −0.8% | −0.7% | −0.9% | −0.4% | −0.6% | −0.3% | −0.5% |
| Week 3 | 0.9% | 0.2% | 0.9% | 0.7% | 1.0% | −1.0% | 0.0% | 0.1% |
| Week 4 | 1.3% | 1.2% | 0.4% | 1.1% | −1.4% | 2.1% | −0.1% | 0.1% |
| Week 5 | −0.3% | 0.0% | −0.1% | −0.4% | −0.9% | −0.2% | 0.6% | −0.3% |
| Week 6 | 3.5% | 2.1% | 2.0% | 2.9% | 0.3% | 1.9% | −0.5% | 0.8% |
| Week 7 | −0.5% | 0.3% | −0.5% | −0.7% | −2.1% | 0.6% | 1.1% | −0.5% |
| Week 8 | −0.1% | −0.4% | 0.0% | 0.3% | 0.8% | −0.1% | −1.6% | −0.1% |
| Week 9 | −0.5% | −0.6% | −0.4% | 0.1% | 0.7% | 0.2% | −2.1% | −0.2% |
| Week 10 | 0.0% | −0.2% | 0.2% | 0.1% | 0.3% | −0.5% | −0.4% | −0.2% |
| Week 11 | −0.6% | 0.2% | −0.5% | −0.8% | −2.0% | 0.5% | 1.1% | −0.5% |
| Week 12 | 0.5% | 0.5% | 0.0% | 0.4% | −0.8% | 1.2% | −0.6% | −0.1% |
| Week 13 | 1.4% | 0.1% | 1.2% | 1.5% | 2.1% | −0.5% | −1.7% | 0.3% |
| Week 14 | 1.1% | −0.1% | 1.4% | 0.8% | 2.1% | −2.0% | −0.2% | 0.2% |
| Week 15 | −1.6% | −0.5% | −1.0% | −1.6% | −1.9% | −0.5% | 1.3% | −0.8% |
| Week 16 | 1.2% | 0.8% | 0.9% | 0.7% | −0.4% | 0.1% | 0.8% | 0.1% |
| Week 17 | 4.7% | 2.8% | 3.4% | 3.2% | 0.5% | 0.1% | 2.4% | 1.0% |
| Week 18 | 2.9% | 1.6% | 2.1% | 2.0% | 0.6% | −0.1% | 1.0% | 0.6% |
| Week 19 | 0.8% | 0.6% | 0.8% | 0.3% | −0.4% | −0.6% | 1.3% | 0.0% |
| Week 20 | 0.7% | −0.2% | 0.5% | 1.0% | 1.5% | 0.0% | −2.0% | 0.1% |

Serial correlation is determined by Idiosyncratic Risk Analysis function 106 by aggregating the weekly idiosyncratic returns of the portfolio (i.e., the weighted average of the idiosyncratic returns of each position or security during each weekly period) to thirteen four-weekly periods. If there is zero serial correlation in the weekly time series of aggregate portfolio idiosyncratic returns then the returns of each week will be statistically independent of every other week (earlier and later). The standard deviation of the time series should increase as the square root of time period. If there is zero serial correlation, the standard deviation of the four-week time-series should be double that of the one week time series. If there is a positive serial correlation, the ratio will be greater than two. If there is negative serial correlation, the ratio will be less than two. Thus, the serial correlation ratio is used to project how the standard deviation of idiosyncratic returns would behave over varying periods of time. For example, this relationship will be used to project the annualized standard deviation of idiosyncratic return (projecting the weekly standard deviation to a year by multiplying the weekly standard deviation of idiosyncratic return by 52 raised to the power of the multiplicative inverse of the serial correlation ratio).

Back Test function 110 iteratively applies the risk factors to a set of securities and calculates statistics on the quality of the explanatory powers of the risk factors. This function is iteratively applied to analyze the quality of alternative risk factor definitions and to support the development of an ultimate set of risk factors that have superior explanatory power. For example, the value style risk factor was optimized by iteratively changing the specific definition of the sub-universe of stocks that are included in defining value (thereby altering the factors used in defining value, the weight applied to each factor, and the percent of stocks ranked by the relevant definition of value selected to create the risk factor) and applying the back test to evaluate the quality of the explanatory power of each alternative definition. Back test function 110 includes a Load Equity function 115 that iteratively loads each equity to be analyzed, a Perform Sensitivity Analysis function 108 (the same as the Perform Sensitivity Analysis function 102 in the Portfolio Handler) that determines the risk factor sensitivity of each equity that the Load Equity Function loads and an Accumulate Statistics function 109 that captures a measure of the explanatory power of the sensitive analysis for each equity that the Load Equity function loads and accumulates aggregate statistics. The primary measure of the quality of the explanatory power is the market capitalization weighted average of the R² (R squared) of the style analyses (regressions) that determined the risk sensitivities. The R² measures the square root of the sum of the squared residuals, and is a standard statistical measure for the quality of fit in a least-square regression.

In an exemplary embodiment, Calculate Risk Factors function 101, Back Test function 110, Portfolio Handler function 103 and Portfolio Analyzer function 104 are packaged in one software program or a suite of software programs so that users of the program(s) can calculate risk factors, apply the risk factors to a particular security portfolio and determine whether the risk/reward of the portfolio is desirable. Alternatively, Calculate Risk Factors function 101 and Back Test function 110, that provide the functionality required to develop and maintain the risk factors, are separately packaged so that users can calculate/maintain risk factors and use those risk factors in other portfolio analysis tools that rely on risk factors to perform financial analysis.

The method of the present invention may be applied to any security including, by way of non-limiting example, stocks, bonds, exchange-traded funds, commodities, currencies, futures, derivatives, and fixed income securities. Also, the methods of the present invention may be encoded using any type of programming language and any suitable software architecture including, by way of non-limiting example, network access devices running Access and communicating SQL queries to a SQL server. Furthermore, any data source may be used to gather historical pricing information and other information required to implement the methods of the present invention.

In an exemplary embodiment, the method and system of the present invention is used to describe the risk profile of a portfolio of securities without having to disclose the actual securities contained in the portfolio. Being able to effectively describe the risk profile of a portfolio without disclosing specific positions is desirable, for example, in the area of hedge funds in which investors seek greater transparency while hedge fund managers desire not to disclose position information. By providing investors with the risk factors associated with the positions held by a hedge fund, investors can determine the suitability of the hedge fund without compromising any confidential information.

Accordingly, under the present invention, a portfolio position is mapped to risk factors so that a risk profile based on sensitivities to risk factors is formed to describe the risk profile of the portfolio without disclosing position level detail. In an exemplary embodiment, the same risk factors are applied across a plurality of funds so that the risk profiles provide a framework for comparing and aggregating the risks of the different funds. Thus, an investor can receive a risk profile of a particular fund as well as a composite risk profile for all the funds held by the investor.

For example, Table 11 below shows risk profiles expressed as sensitivities to risk factors for three sample funds. (The risk factors in this example include the US Equity Market, Value as a sample style factor, and Materials & Financials as sample industry factors and precious & base metals as sample commodity risk factors):

TABLE 11

| | | Net | US | | | | Finan- | Precious | |
|---|---|---|---|---|---|---|---|---|---|
| | Security | Weight | Market | Value | Tech | Materials | cials | Metals | Base Metals |
| Fund A | IBM | 70% | 1.4 | 0.4 | 0.4 | | | | |
| | MSFT | −10% | 2.0 | −1.2 | 1.3 | | | | |
| | IP | 50% | 0.7 | 0.3 | | 0.7 | | | |
| | 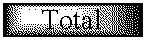 | 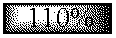 | 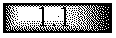 | 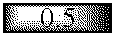 | 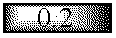 | 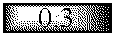 | | | |
| Fund B | MSFT | 50% | 2.0 | −1.2 | 1.3 | | | | |
| | C | 30% | 0.9 | 0.1 | | | 1.2 | | |
| | Nueor | −20% | 0.6 | 0.7 | | 0.4 | | | |
| | 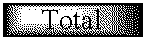 | 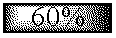 | 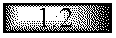 | 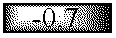 | 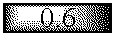 | 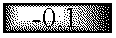 | 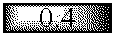 | | |
| Fund C | Gold | 120% | | | | | | 1.1 | |
| | LME | −40% | | | | | | | 0.9 |
| | Copper | | | | | | | | |
| | 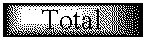 | 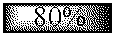 | | | | | | 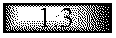 | 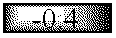 |

The gray rows present fund level risk profiles that report the sensitivity of the fund to risk factors without disclosing position detail. The risk profile also includes a portfolio weekly idiosyncratic risk time-series that permits the same idiosyncratic risk analysis that was previously described for securities within a fund to be performed across funds in a fund of funds. The sensitivities to risk factors are additive (weighted by the net exposure of each position) so the total exposure for each risk factor, shown in the gray row titled “Total” for each fund, is the weighted average sum of the sensitivities of each position to that risk factor (e.g., 70% times 1.4 plus—10% times 2.0 plus 50% times 0.7% for the sensitivity to the US market for Fund A). This framework permits cross-fund comparisons such as the fact that Fund B is more sensitive to “Tech” than Fund A (Fund B's sensitivity is 0.06 and Fund A's sensitivity is 0.2). Finally, an investor in a portfolio of funds can aggregate the risk factor sensitivities communicated in the risk profiles of each individual fund across funds and an aggregate risk profile for a portfolio of funds can be calculated, as shown in Table 12, (applying the same methodology as was used to calculate a risk profile of an individual fund):

TABLE 12

| | | | US | | | | Finan- | Precious | |
|---|---|---|---|---|---|---|---|---|---|
| | Security | Net Weight | Market | Value | Tech | Materials | cials | Metals | Base Metals |
| Fund A | Total | 50% | 1.1 | 0.5 | 0.2 | 0.3 | | | |
| Fund B | Total | 30% | 1.2 | −0.7 | 0.6 | −0.1 | 0.4 | | |
| Fund C | Total | 20% | | | | | | 1.3 | −0.4 |
| 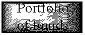 | 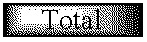 | 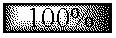 | 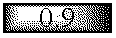 | 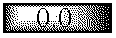 | 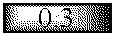 | 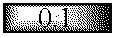 | 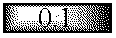 | 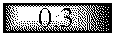 | 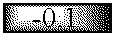 |

While it is preferred that the risk profile for a particular fund or a composite of funds is determined using the risk factors described herein, other risk factors may be used to describe the risk profile of various funds for determining the desirability of a particular fund, for determining the composite risk profile of a portfolio of funds or for comparing the risk profile of different funds.

In an exemplary embodiment, a system is provided that receives and stores risk factor based risk profiles from funds/managers. Upon receiving a request from an investor, the system compiles a composite portfolio of all the funds/managers in which the investor is invested and provides the investor with a risk profile for the composite portfolio. In addition, the system may provide the investor with other reports including, by way of non-limiting example, comparative risk/return statistics in total and by style, an aggregated profile of their portfolio of funds/managers and comparative statistics for each of the managers.

Accordingly, a method is provided for calculating and maintaining risks factors associated with a particular security included in a basket of securities and for using those risk factors to analyze the risk profile of the portfolio.

A number of embodiments of the present invention have been described. Nevertheless, it will be understood that various modifications may be made without departing from the spirit and scope of the invention. Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, SQL, Oracle and DB2, as a platform for implementing the present invention. Also, network access devices can comprise a personal computer executing an operating system such as Microsoft Windows™, Unix™, or Apple Mac OS™, as well as software applications, such as a JAVA program or a web browser. Network access devices can also be a terminal device, a palm-type computer, mobile WEB access device or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A method for calculating a risk factor associated with a security, comprising the steps of:
tabulating data pertaining to said security;
calculating a plurality equity style factors;
calculating equity industry factors; and
orthogonalizing said equity style factors and said industry factors.

2. The method of claim 1, wherein said data includes including price information, dividend information, fundamental data and multi-class share information.

3. The method of claim 2, wherein said fundamental data includes trailing 12 month earning per share data, trailing 12 month dividends per share data, book per share, balance sheet shares information and turnover, and currency information.

4. The method of claim 2, further comprising the step of:
adjusting the price and dividend information for currencies and calculating the daily returns for said security.

5. The method of claim 2, further comprising the step of:
aligning the fundamental data;
currency converting the fundamental data; and
distributing the balance sheet shares across each of the share classes of the multiclass shares.

6. The method of claim 1, wherein said plurality of equity style factors include value, large cap, EPS growth, EPS variability, return volatility, leverage and illiquidity.

7. The method of claim 6, wherein the step of calculating a plurality of equity style factors includes the steps of:
identifying a plurality of groupings of securities by country/region; and
selecting a sub-universe of securities for each of said grouping using said plurality of style factors.

8. The method of claim 7, wherein the step of selecting a sub-universe includes the step of:
creating a market cap weighted index of daily returns of each sub-universe for each style factor for each country/region.

9. The method of claim 1, wherein said plurality of style factors include earnings momentum, merger arbitrage and idiosyncratic style factors.

10. The method of claim 1, wherein the step of calculating equity industry factors includes the step of:
segmenting securities for each country/region by GICS level 2 grouping; and
creating a market cap weighted index of the daily returns of each group of securities for each country/region.

11. The method of claim 1, wherein said securities are commodities and said industry factors include energies, grains, tropicals, meats, precious metals and base metals.

12. The method of claim 1, wherein the step of orthogonalizing said risk factors includes the step of:
sequentially regressing a return history of dependent risk factors with return histories of independent risk factors.

13. The method of claim 1, further comprising the step of:
determining a sensitivity of said security to risk associated with said plurality of risk factors.

14. The method of claim 13, wherein the step of determining at least one risk factor sensitivity includes the steps of:
calculating a plurality of risk factors associated with the security, said plurality of risk factors including industry risk factors and style risk factors;
calculating a daily risk factor for said security for each of said plurality of securities;
aligning said daily risk factors with daily returns for said security;
forming a matrix calendar days as rows and the plurality risk factors as columns;
performing a regression on the matrix;
eliminating said industry risk factors having negative sensitivities;
eliminating style risk factors having a t-Stats value less than 1.65;
determining a daily modeled return for said security 1; and
calculating a daily residual by subtracting the daily-modeled return from the actual daily return for said security.

15. The method of claim 13, wherein said security is included in a portfolio of securities and wherein the method further comprises the step of:
performing portfolio analysis to said portfolio of securities.

16. The method of claim 15, wherein the step of performing portfolio analysis includes the steps of:
creating a long-term history based on said risk factors; and
performing an idiosyncratic risk analysis.

17. The method of claim 16, further comprising the step of:
performing a risk factor based risk decomposition and a risk factor based performance attribution.

18. The method of claim 17, further comprising the step of:
performing other financial analyses including analysis of returns (e.g., compound annual, percent up months), volatility (e.g., standard deviation, downside deviation, semi deviation, tracking error), correlation (e.g., correlation coefficient, beta, alpha), risk-return measures (e.g., Sharpe, Sortino, information ratios), leverage, and the distribution of residuals (e.g., kurtosis, skew).

19. The method of claim 16, wherein the step of creating a long-term history includes the step of:
calculating the daily risk factor returns for each risk factor;
compounding monthly daily risk factor returns; and
multiplying the compounded monthly returns by the risk factor sensitivities of each security in the portfolio.

20. The method of claim 17, further comprising the step of calculating marginal standard deviation;
calculating marginal drawdown; and
calculating marginal Value at Risk wherein the VaR confidence limit is flexibly defined.

21. The method of claim 17, further comprising the step of:
calculating the structural fund returns based on both the actual aggregate risk factor exposures each month and the average aggregate risk factor exposures by applying the respective sensitivities to each month's risk factor returns.

22. The method of claim 16, wherein the step of performing idiosyncratic analysis includes the step of:
determining a level of multicolinearity across securities in the portfolio; and
measuring serial correlation.

23. The method of claim 22, wherein the step of determining a level of multicolinearity includes the step of:
measuring by regressing an idiosyncratic return of each security in the portfolio versus an idiosyncratic return of the entire portfolio excluding said each security.

24. The method of claim 22, wherein the step of measuring serial correlation includes the step of:
accumulating weekly idiosyncratic returns of the portfolio of securities for a period.

25. The method of claim 24, wherein said period is a four-week period.

26. The method of claim 1, further comprising the step of:
iteratively applying the risk factors to a set of securities; and
calculating statistics on the quality of the explanatory powers of the risk factors.

27. Computer executable program code residing on a computer-readable medium, the program code comprising instructions for causing the computer to:
tabulate data pertaining to said security;
calculate a plurality equity style factors;
calculate equity industry factors; and
orthogonalize said equity style factors and said industry factors.

28. The computer executable program of claim 27, wherein said data includes including price information, dividend information, fundamental data and multi-class share information.

29. The computer executable program of claim 28, wherein said fundamental data includes trailing 12 month earning per share data, trailing 12 month dividends per share data, book per share, balance sheet shares information and turnover, and currency information.

30. The computer executable program of claim 28, wherein the program code additionally causes the computer to:
adjust the price and dividend information for currencies and calculating the daily returns for said security.

31. The computer executable program of claim 28, wherein the program code additionally causes the computer to:
align the fundamental data;
currency convert the fundamental data; and
distribute the balance sheet shares across each of the share classes of the multiclass shares.

32. The computer executable program of claim 27, wherein said plurality of equity style factors include value, large cap, EPS growth, EPS variability, return volatility, leverage and illiquidity.

33. The computer executable program of claim 32, wherein the program code additionally causes the computer to:
identify a plurality of groupings of securities by country/region; and
select a sub-universe of securities for each of said grouping using said plurality of style factors.

34. The computer executable program of claim 33, wherein the program code additionally causes the computer to:
create a market cap weighted index of daily returns of each sub-universe for each style factor for each country/region.

35. The computer executable program of claim 27, wherein said plurality of style factors include earnings momentum, merger arbitrage and idiosyncratic style factors.

36. The computer executable program of claim 27, wherein the program code additionally causes the computer to:
segment securities for each country/region by GICS level 2 grouping; and
create a market cap weighted index of the daily returns of each group of securities for each country/region.

37. The computer executable program of claim 27, wherein said securities are commodities and said industry factors include energies, grains, tropicals, meats, precious metals and base metals.

38. The computer executable program of claim 27, wherein the program code additionally causes the computer to:
sequentially regress a return history of dependent risk factors with return histories of independent risk factors.

39. The computer executable program of claim 27, wherein the program code additionally causes the computer to:
determine a sensitivity of said security to risk associated with said plurality of risk factors.

40. The computer executable program of claim 39, wherein the program code additionally causes the computer to:
calculate a plurality of risk factors associated with the security, said plurality of risk factors including industry risk factors and style risk factors;
calculate a daily risk factor for said security for each of said plurality of securities;
align said daily risk factors with daily returns for said security;
form a matrix calendar days as rows and the plurality risk factors as columns;
perform a regression on the matrix;
eliminate said industry risk factors having negative sensitivities;
eliminate style risk factors having a t-Stats value less than 1.65;
determine a daily modeled return for said security 1; and
calculate a daily residual by subtracting the daily-modeled return from the actual daily return for said security.

41. The computer executable program of claim 39, wherein said security is included in a portfolio of securities and wherein the program code additionally causes the computer to:
perform portfolio analysis to said portfolio of securities.

42. The computer executable program of claim 41, wherein the program code additionally causes the computer to:
create a long-term history based on said risk factors; and
perform an idiosyncratic risk analysis.

43. The computer executable program of claim 42, wherein the program code additionally causes the computer to:
perform a risk factor based risk decomposition and a risk factor based performance attribution.

44. The computer executable program of claim 43, wherein the program code additionally causes the computer to:
perform financial analyses in the group including analysis of returns, volatility analysis, correlation analysis, leverage analysis and the distribution of residuals.

45. The computer executable program of claim 42, wherein the program code additionally causes the computer to:
calculate the daily risk factor returns for each risk factor;
compound monthly daily risk factor returns; and
multiply the compounded monthly returns by the risk factor sensitivities of each security in the portfolio.

46. The computer executable program of claim 43, wherein the program code causes the computer to calculate the marginal standard deviation, marginal drawdown, and marginal Value at Risk.

47. The computer executable program of claim 43, wherein the program code causes the computer to calculate the structural portfolio returns based on both the actual aggregate risk factor exposures each month and the average aggregate risk factor exposures by applying the respective sensitivities to each months risk factor returns.

48. The computer executable program of claim 42, wherein the program code additionally causes the computer to:
determine a level of multicolinearity across securities in the portfolio; and
measure serial correlation.

49. The computer executable program of claim 48, wherein the program code additionally causes the computer to:
measure by regressing an idiosyncratic return of each security in the portfolio versus an idiosyncratic return of the entire portfolio excluding said each security.

50. The computer executable program of claim 48, wherein the program code additionally causes the computer to:
accumulate weekly idiosyncratic returns of the portfolio of securities for a period.

51. The computer executable program of claim 50, wherein said period is a four-week period.

52. The computer executable program of claim 27, wherein the program code additionally causes the computer to:
iteratively apply the risk factors to a set of securities; and
calculate statistics on the quality of the explanatory powers of the risk factors.

53. A method for determining a risk profile of a portfolio having a plurality of securities, comprising:
identifying at least one risk factor associated with said plurality of securities; and
calculating a sensitivity of each of said plurality of securities to said at least one risk factor; and
combining said sensitivities to form said risk profile for said portfolio.

54. The method of claim 53, wherein the step of identifying includes the steps of:
tabulating data pertaining to each of said plurality of securities;
calculating a plurality equity style factors;
calculating equity industry factors; and
orthogonalizing said equity style factors and said industry factors.

55. The method of claim 53, wherein said portfolio includes position information and said method further comprising the step of:
communicating said risk profile without disclosing said position information.

56. The method of claim 55, further comprising the steps of:
receiving a plurality of risk profiles associated with a plurality of portfolios, respectively; and
calculating an aggregate risk profile for the plurality of portfolios based on the plurality of risk profiles.
